(19) United States
(12) Patent Application Publication
(10) Pub. No.: US 2005/0010485 A1
(43) Pub. Date: Jan. 13, 2005

(54) Integrated system and method for selectively populating and managing multiple, site-specific, interactive, user stations

(75) Inventors: Fuad Sarvestani, Englewood, CO (US); Masoud Sharifi, Denver, CO (US); Joseph Berry, Aurora, CO (US)

Correspondence Address: LEE G. MEYER, ESQ.;MEYER & ASSOCIATES, LLC, 17462 E. POWERS DRIVE, CENTENNIAL, CO, 80015-3046, US

(73) Assignee: Quadratic Systems Corporation

(21) Appl. No.: 10/618,509

(22) Filed: Jul. 11, 2003

(51) Int. Cl. G06F 17/30

(52) U.S. Cl. 705/26; 705/27; 707/200

(57) ABSTRACT

A multimedia, interactive kiosk system for use in site-specific locations, which enables the user to interface the system quickly and easily and interact with the system in response to information provided within wide limits of variation. The system provides customized interfaces for thousands of multimedia kiosks by presenting selected information from numerous independent information sources directed to the programmed site-specific aspects of the kiosk and allows the user to interact with the information as well as Vendor/subscribers providing services in response to the selected information. The multimedia, interactive kiosk system uses an interactive database at the kiosk site which is periodically updated from a multitask server engine in response to user commands or system criteria. Links are provided from the interactive database for periodic updates, multimedia presentations, and interactive manipulation by the location user.

### BACKGROUND OF THE INVENTION

1. Field of the Invention

The present invention relates generally to a distributed electronic, selective population and management system for site-specific, user stations; and, more particularly, to site-specific delivery of electronic information to, and interactive management of information for presentation, presentation protocol, and information based transactions at multiple, interactive User Stations which present a myriad of site-specific, layered information to users who can interact therewith.

2. Description of Related Art

An electronic information user station, or kiosk, is a site-specific, information venue, generally accessible to some segment of the consuming public for retrieving selected information and/or initiating information based transactions with third party merchandisers and/or service providers. An individual user station can include for example, a display screen for presenting information to the user and some form of input/output, such as a credit card reader, PDA port, and/or printer, and at least one data manipulation device for user interface, such as a touch screen or keypad. The user station hardware and functionality is generally dictated by the information to be displayed and the functions that can be performed. The presentation protocol is authored to be compatible with the content and functionality of the station.

The type of “site-specific” information presentation and information based transaction system of interest here is an interactive system having multiple, site-specific, interactive, user stations with multimedia interface. A user at an individual user station can select a topic and/or search for information about a topic from a large database of information and then interact with the system to accomplish an electronic transaction, if desired.

Such user station “systems” have become popular in recent years. They are found, for example, at museums and exhibitions, airports, public transportation stations, banks, and even in retail establishments for use by the customers. Examples of kiosk systems are disclosed in U.S. Pat. No. 4,817,043 of Brown, U.S. Pat. No. 4,974,170 of Bouve et al., and U.S. Pat. No. 5,237,157 of Kaplan. Recently multimedia user stations or kiosks, which present information to the user, not only as text on the display screen, but also in the form of graphics, audio clips, animated sequences of still images, and even video clips have been introduced.

There has also been an attempt to stratify electronic user stations, making them more functional and specific to a particular location, while maintaining speed and flexibility. The development of an electronic kiosk system comprising a large number of individual kiosks or user stations located at a variety of different sites for providing a selection of information customized to each site has been a goal. The information, which is available to a user at an individual user station, depends on the nature of the location in which the user station is located and the interactive function to be performed. A kiosk at a hotel, for example, may provide information about the services provided in the hotel, local entertainment, restaurants, places of interest, airline schedules, local vendors, and the like.

In addition, a multimedia kiosk at a local hotel may also provide information about, for example, local ski areas, ski conditions, and provide the user with information about rental of ski equipment, ski shops, rental cars and the like. This kiosk may also provide information on lift tickets, specific ski runs, ski school, day care, as well as information on ski rental, shops, and restaurants at the resort. Other local attractions such as boating, fishing, white water rafting, hunting, mountain claiming, and the like, could be similarly advertised and/or information provided by a user station in a local that caters to such activities. A hotel kiosk may also provide the user with interactive ability to access a myriad of non-hotel related services, such as purchase of airline tickets, ATM, purchase of theater tickets, purchase of lift tickets, and the like.

A particular vendor, retailer, or merchandiser, for example, may want to display an initial stylistic presentation of the logo and brand-name recognition, perhaps overlaid on a graphic image of a sky-line or an animated clip including audio and video components. For more complicated sales interaction, the kiosk may present a video clip, perhaps accompanied by an audio portion, showing the product in its specialized use. For information on a restaurant the kiosk may display a graphic image depicting patrons in the restaurant to show the atmosphere and dress appropriate to the restaurant. The kiosk may also display the restaurant menu, either as a computer text file, or as a graphic image of a stylish menu used in the restaurant. In addition, pictures of particular house specialties may be overlaid as a continuing slide presentation of the menu. All of this content must be accompanied by authored protocol to appropriately display or play the content.

These examples are only a few of the possibilities for user interactive information at a site-specific kiosk. The information may comprise an ever expending set of information which may start with the amenities of a specific location broadcast to a local, then a district, then a city, then a region, and so on. This “broadcast” or presentation of interactive information needs to be constantly updated. Thus if the information were stored and manipulated solely from a central location, it would be almost impossible to manage without very elaborate, interactive search engines. These require large interaction times and formidable bandwidth on communication link, not only for this interconnect, but also the real time search and download of the information.

The problem is intensified as each user station presentation of information for user interface is updated or changed. For example, a kiosk that displays a graphic image of patrons at a restaurant to show the atmosphere and appropriate dress may find it desirable to change the graphic image with the season, since a scene showing winter dress would not be appropriate in the summer. A dress shop may not carry precisely the same lines of clothes from one season to the next, and its kiosk will have to be modified to show the current styles.

Sometimes more extensive modification will be needed. A sports shop that carries winter equipment and sports wear specializes in other sports equipment in the summer, for example, swimming, tennis, golf, boating, or hiking. The kiosk's user interface would have to be extensively revised with the changes in season to reflect the shop's new emphasis and goods, and the information content available to the kiosk would have to be updated to include the summertime goods and activities. A shop or hotel that displays information on ski areas in the winter may want to display information about tennis, golf, fishing, and other outdoor activities in the summer. In any one geographical region changes of this sort may have to be made to hundreds of kiosks or more.

Some of the problems to be overcome to make a system of this sort commercially viable are the organization of the data for potentially hundreds of user stations, and even more data sources, so that a customized selection of data will be accessible to users at each of the kiosks; the customization of the user interface for each of the potentially hundreds of user stations, or more, in a manner that is economically feasible; the ability to update the data available to the user stations quickly and easily; and the ability to modify the user interface of any one user station quickly and easily. Central databases cannot manage this task efficiently in real time. Likewise, maintaining the complete database at each user station is inflexible, if not impractical and makes updates cumbersome.

In addition to the mere retrieval of interactive information, user station specific, computer interface screens need to be created and modified. This requires operating programs, which design the layout of a display screen such as the size, character, and placement of buttons and windows on the screen and combine text, graphics, audio, and video into a user-friendly application screen interface. In a central database system, these “authoring” systems, which are unique to a user station, or set of user stations, must be downloaded with each use from a central database prior to populating the information on the user station. In addition, the operating system must have the capability to integrate different media, which includes full application-building programmability, similar to that found in database packages. Most authoring tools define a screen and the specific attributes of the screen such as the definition of a video window that will play a specified video clip or show a text file or a graphic image.

If these systems are centrally located, the server interface and table lookup time to perform all these functions is horrific. Alternatively, housing all site-specific information, as well as all the other required information and the authoring system (display protocol) on a single user station is slow, inflexible, and cumbersome to update. In addition, interactive functions, such as ordering tickets, restaurant take-out, rental car reservations, and the like, add another dimension of complexity and inflexibility to the system.

As can be imagined, the customization of information and interaction of a site-specific, user station can be a formidable task. There are a number of possibilities for populating and managing individual user station user interfaces, especially for a multimedia user station. The sequencing of this information and the corresponding interactive aspect of user interface is not only a difficult information-handling task, but can present a number of information related problems. For example, if, a number of kiosks are collectively linked, real time, to a single database, interactive look-up, upload, and download times can be substantial. However, maintenance of a central database, which contains substantially all updated information to be displayed, and all interactive connections for transactions at the individual user station, provides ease of data and transaction management. Likewise, if all information and data relative to a specific site is stored within the hardware/software interface at the specific kiosk location, the flexibility of the system is compromised, but the ease and speed of user interaction is increased. However, changing information overlays and sequencing for hundreds of individual user stations can be a formidable task. Further, interactive services present an additional element of complexity in information management, not to mention security.

Previously, prior art systems, such as that disclosed by Burns in U.S. Pat. No. 6,014,137 have attempted to place all operational tasks in a look-up table, which is either centralized or exists solely on an individual kiosk. These systems are disadvantaged in that they require complicated look-up systems and/or large individual storage devices and reduce the flexibility of a multi-informational kiosk system as well as substantially increasing the mean time to access of the particular information for a specific local. As the required or desired information for a particular kiosk increases, so does the operating system complexity, as well as the total volume of the look-up table.

It would, therefore, be advantageous to have a complete and comprehensive system, with both hardware and software applications, which uses a uniform system interfacing protocol to integrate user stations. It would also be advantageous to have a system for use in site-specific locations, which enables the user to interface the system, quickly and easily; and, interact with the system in response to information provided within wide limits of variation. It would also be advantageous to have a system capable of providing customized interfaces for thousands of multimedia user stations by presenting selected information from numerous independent information sources, using specific authored presentation protocols, directed to the site-specific requirements of the user station while allowing the user to interact with the information, as well as vendors providing services, in response to the selected information.

### SUMMARY OF THE INVENTION

The present invention provides a system and method for populating and managing information flow, protocol, and content to and from multiple, site-specific, interactive, multimedia User Stations, wherein site-specific information and protocol, including authoring tools, interactive communication protocol and systems protocol, are stored at the User Station and periodically updated, by use of a System Transaction Manager, from a Central Database in accordance with a system schedule or upon user demand. The information content, although site-specific, is layered such that the data on the User Station forms the center or locus of an ever expanding set of information, from location specific to local to region to state etc. A System Administrator sets system policy by which the System Transaction Manager carriers out the prioritizing, routing, downloading, and look-up functions.

The instant invention comprises an electronic system or network, for initially populating and periodically updating uniquely identified Vendor/subscriber Information to Indexed User Stations, using a uniform system protocol, wherein at least one entity is generating said information and at least one User Station receives such information, the system having at least one System Transaction Manager for facilitating the transmission over a communications link and managing the information and protocols, wherein the System Transaction Manager communicates with at least one information generating entity and at least one User Station. The at least one generating entity communicates with the System Transaction Manager and is able to generate formatted Information, able to transmit the information over the communication link to the System Transaction Manager, and able to receive a formatted acknowledgement over the communication link using the uniform system protocol. The at least one User Station, communicates with the System Transaction Manager and is able to receive formatted information and protocols over the communication link, is able to generate a formatted acknowledgment for said information and is able to transmit a formatted acknowledgment over the communication link.

In accordance with the invention an integrated system for populating and managing multiple, site-specific, interactive, Indexed User Stations in accordance with a preset schedule or User command is provided. Advantageously, the User Station is multimedia. The system has at least one System Transaction Manager, which operates using a uniform system protocol for facilitating the population of the User Station with site-specific, layered information and certain operating protocol; and, updating the information and protocol in accordance with a system schedule or in response to a User Station command, over a communications link wherein the System Transaction Manager communicates with at least one User Station and at least one information/protocol generator. The User Station(s), in communication with the System Transaction Manager is able of storing site-specific, layered information for retrieval and use by the User at the User Station in accordance with a site-specific operating protocol, and, able to receive updated site-specific, layered information and changes in the site-specific operating protocol.

The present invention presents a homogeneous method for providing layered, site-specific information to Indexed User Stations, as well as conducting electronic business and/or transactions using a communications link, all as managed by the System Transaction Manager. The System Transaction Manager populates the Indexed User Stations with site-specific information and protocol based upon the User Station Index, then periodically updates the information from the Central Database to the specific User Stations, based upon requirements of the information providers (generators), system requirements, and user commands. The System Transaction Manager routes generated information such as Vendor/subscriber Information, including updated display protocol, when required, to the Central Database, as well as providing real time User interface from the User Station to third party information, goods and services.

In accordance with one embodiment of the invention, Vendor/subscriber information, received by the System Transaction Manager, contains a system header. Preferably, the system header is information used by the system to follow routing, such as index fields, and the system data portion is the substance of the Vendor/subscriber information. The system protocol for a specific User Station can be placed in either the header or the data portion or both.

In accordance with one embodiment, a confirmed transmission of uniquely identified and processed Vendor/subscriber information and operating protocol, provided by at least one generating entity, such as a Vendor/subscriber, to at least one Indexed User Station is accomplished by use of a System Transaction Manager having an information processing, authentication, and routing means, which communicates by means of a link between the Central Database and each User Station on the network. The Vendor/subscriber information is uniquely routed by means of identification of the index referenced in the Central Database and unique to a User Station. In one embodiment, the set of User Stations to be accessed and populated are uniquely identified by information, which accompanies the Vendor/subscriber Information and resides in the Central Database. The system of the instant invention confirms transmission of information to maintain the update integrity of the system.

The system of the instant invention enables the information, operating protocol, for each individual Indexed User Station to be customized quickly and easily within wide limits of variation at predetermined, or requested intervals by the System Transaction Manager. The system of the instant invention enables updated information and custom interfaces to be selectively down-loaded to specific User Stations at predetermined or requested intervals from the Central Database by the System Transaction Manager, as well as real time interaction with third parties, in response to User commands.

The System Transaction Manager is able to provide for organization and storage of information, from numerous information providers, on the Central Database, as well as access to a number of service providers. In one embodiment a Vendor/subscriber is also a service and/or goods provider, such as, for example, a rental car company that also advertises on the User Stations. The system makes it easy to set up, maintain, and update a great variety of Indexed User Stations with a large quantity of layered information or content as well as operating protocol. The System Transaction Manager populates the specific User Station at intervals or on user command with updated content from the Central Database. In accordance with one embodiment, the Central Database comprises an Information Database and a Protocol Database.

Each Indexed User Station contains stored customized, layered, updated information on the User Station, which is populated from the Central Database as managed by the System Transaction Manager in accordance with the system policy administered by the System Administrator. Likewise, the operating system protocol is installed on the Indexed User Station and updated from the Central Database as managed by the System Transaction Manager. When a new Vendor/subscriber provides information to the system, the System Transaction Manager easily incorporates it into the Central Database, in accordance with the system's policy, so that the new content is available to be delivered to each appropriate Indexed User Station. In this manner all individual User Stations have the entirety of the latest site-specific and system information available to them without the delay of establishing a real time interface between the Central Database and the User Station every time a User uses the User Station. In addition, the present system avoids the need to keep track of differing versions of information at the User Station level.

In accordance with another aspect of the invention, User business transactions are facilitated, real time, by the System Transaction Manager. In another aspect, real time data from online web sites is provided to the User at a User Station through the System Transaction Manager as a gateway and/or a monitor facilitator.

### BRIEF DESCRIPTION OF THE FIGURES

The objects, features, and advantages of the present invention will be apparent to one skilled in the art, in view of the following detailed description in which:

FIG. 1 is a schematic view of an information exchange system of the prior art;

FIG. 2 is a flow chart showing the information processing and transfer system for a client server network in accordance with the instant invention; and

FIG. 3 is a flow chart showing the information processing and transfer system for an internet based network in accordance with the instant invention;

### DISCUSSION OF THE SYSTEM NOMENCLATURE

As used herein, the following terms will have the meanings hereinafter set forth. Internet Protocol is the communications protocol used on the Internet. In addition, TCP/IP has become the de facto communications protocol in most user networks. The extended Markup Language (XML) is a self-defining data stream that allows embedding of data and descriptions using tags. In addition, the language provides a number of formatting capabilities. Application Protocol is the protocol, which a User Station uses to support interaction with requested information and responses to third party service/goods providers, usually over the Internet. It is through this Application Protocol that a responder will respond to a request. Communications Protocol is the communications protocol that the User Station uses to support native communication, primarily with the System Transaction Manager. For most transactions, the Communications Protocol and the Application Protocol must be used to access the core processes, i.e. the Business Protocol of the requestor or responder. A Subscriber/vendor is a business entity on the network that subscribes to the system and generates informational content, such as advertising to the system. A Subscriber/vendor may also provide authored operation protocol for presentation of certain informational content provided to the system by the Subscriber/vendor. The Subscriber/Vendor can also be a third party service provider that interacts with the system to provide goods/or services.

A User Station is a site-specific unit in the system, usually multimedia and multi-functional, having I/O, storage, and a communication link with the System Transaction Manager and/or third parties. An Indexed User Station has an ID as a system identifier, which is used to uniquely identify a particular station and its operating protocol within the system and can be field or information designated. The Index is the primary means by which the System Transaction Manager keeps track of the User Station activity, protocol, and information within the system. A User Station contains the majority of the functionality of the system, and receives scheduled updates of both content and operating protocol from the System Transaction Manager. A Request is a query or a transaction with a third party, handled by the User Station, or sent to the System Transaction Manager over the network, by a User. A Response is a reply to a Request by a User. A Requester is a User that makes a Request for some products, services, or information through the System Transaction Manager and/or a third party. A Responder is the System Transaction Manager and/or a provider, who is able to satisfy or answer the Request of a User. A Responder provides a Response to the Request of a Requester. Business Protocol is a group of processes, within a Responder's business system, that directly supports some business process and is accessed by the system Communications Protocol. Examples of Business Protocol include order entry, checking the order's status, pricing, availability and the like. The Industry Application Programming Interface is an interface for developed programs that allow these programs to be able to Request access to products, services, and information related to that industry. In the example of purchasing, the interface will provide the capability to place orders, check order status, etc. Pre-existing Public Communication System is a communication link which is accessible to the Users and which can support the electronic transmission of data, including, for example, the Internet. Central Information Database is an Indexed content data repository. Central Protocol Database is an Indexed protocol repository. The Central Information Database and the Central Protocol Database comprise the Central Database. The System Administrator sets the network policy and tests the Vendor/subscriber information for content compatibility, and determines priority and Index designation for the System Transaction Manager.

### DETAILED DESCRIPTION OF THE INVENTION

The instant invention provides a method and system for populating and managing information on site-specific, indexed, multi-functional, multimedia User Stations. Both, content and protocol, are maintained and updated according to system policy (set by the System Administrator) in a Central Database, which can comprise a single or more than one unit in a distributed system. The System Transaction Manager updates a site-specific Indexed User Station based upon Vendor/subscriber information input, system protocol updates, and system policy as administered by the System Administrator. The Vendor/subscriber(s) is the primary generating entity, and generates content in a myriad of formats, which are reduced to electronic medium. Content can be in a form of audio or video. In one embodiment, protocol for displaying content at specific User Station is provided by Vendor/subscriber in connection with content provided to the Central Information Database. In this embodiment, protocol, associated with such content, is stripped by the System Transaction Manager and routed to the Central Protocol Database to be integrated with the system protocol and provided as a protocol update to the Indexed User Stations presenting the content.

In another aspect, the protocol is a system's protocol generated on a system basis and parsed to particular Indexed User Stations depending upon their presentation capability, the content displayed, and the uniqueness of the Vendor/subscriber information to be provided to the specific User Station. In accordance with this embodiment, protocol is authored and provided by programmers for the system and split in accordance with the policy of the System Administrator between the Central Protocol Database and the individual Indexed User Station. In this manner, protocol required to display content contained on a specific User Station is stored locally at the station to mitigate the requirement for Central Protocol Database/User Station real time interface.

The Protocols of the instant invention are systems or ways of internally carrying out business within a Users Stations. They can be of a legacy type, employing Native Application Protocol and/or Native Communications Protocol to access the core processes of the system protocol, a type compatible with particular business systems, or even those utilizing the uniform system protocol. Other known protocols can be used to affect the operation of the system. The inventive system has the ability to be readily integrated with any hardware, any application software (including custom software), or any processing method or device. It has the capability to be used effectively through the Internet, the Intranet, VPN, LAN, WAN, or even wireless transmission. It also has the ability to interface with, for example, Windows, Novell, Unix, Linux, or MAC OS.

The links between the User Station and the System Transaction Manager can be any well known in the art including, for example, cable, direct satellite uplink, cellular broadcast, or the like. In one embodiment, the system employs a VPN in a client/server configuration. In another embodiment, the Internet is used to provide the link between the System Transaction Manager and the individual User Stations. It will be understood, that a variety of these links can be employed in a single system depending upon convenience, expense, etc. Additionally, a single User Station can employ more than one link mode in accordance with the invention.

In accordance with an advantageous aspect, the System Transaction Manager acts as a “gateway” to facilitate direct communication between the User Station and third party service providers, including web based providers on the Internet. In accordance with this embodiment, users at a User Station equipped with, for example, charge card purchase capability, are allowed to interface directly with, for example, merchandise vendors, service providers, and the like. An example might be purchasing tickets to a local play or sporting events by use of a service such as TicketTron® or TicketMaster®. Alternatively, web access can be made available by the System Transaction Manager to purchase merchandise or tickets directly from a providers' web page on the Internet.

The Central Database incorporates a distributed software application system for capturing, indexing, and storing of information, using a uniform system protocol, wherein, for example, at least one Vendor/subscriber generates or updates the content of the information to be transferred to specific User Stations. The system employs the System Transaction Manager, functioning as a broker or router, between the User Stations and information generators by way of the Central Database for processing and disseminating the information and/or operating protocol to a specific User Station either in batch process or, when required, in real time. The System Administrator sets system policy and prioritizes the information and sets the index for the User Station against which incoming content is matched based upon, for example, Vendor/subscriber identity. The download triggers, as discussed below, are also indicated.

As the System Transaction Manager stores the information and/or operating protocol on the Central Database, it sets a trigger, such that the next time that indexed information is to be downloaded to the Indexed User Station the System Transaction Manager will download the new information. Once the information is downloaded, the trigger is pulled, indicating that there is nothing new to download to the Indexed User Station on the next scheduled download. Information lacking complete direction for the System Transaction Manager is cached, as will be further described.

Vendor/Subscriber

In accordance with the instant invention, Vendor/subscribers are the primary generating entity for providing content for the system to be placed in the Central Database. The content, which is formatted for the system, can be any combination of audio and/or video to be displayed/played on the User Station in accordance with the operating protocol of the system. The Vendor/subscriber can deliver content to the system link or by batched media via electronic link or batched media such as CD disk or the like.

It will be realized by the skilled artisan that the content can be delivered as graphics and audio, in any format, including hard copy pictorial, or electronic. When the content is delivered, in other than formatted electronic medium compatible with the system, it is translated to compatible electronic format, as is well known in the art. The content, appropriately formatted, is then stored in the Central Database for use in accordance with the operation of the system as previously described.

User Station

The User Station, in accordance with the instant invention, can be any hardware facility or assembly, which provides the input, output, and storage capability compatible with the system. It is indexed for identity in the system. It will be realized that since data content and protocol for a particular User Station are site-specific, that sufficient memory must be present to facilitate both content and operating system for the material to be displayed and the transactions to be completed at the particular User Station. Advantageously, the User Station contains a video display such as CRT, plasma screen, or the like. In some embodiments, the screen also acts as input to the system such as by use of touch screen software. Audio output, such as speakers, where, for example, audio clips such as music or narrative can be played as well as providing in some instances response to voice activated recognition. Input devices include touch screen keypads and microphones for voice activated or initiated interaction with the content and/or transactions housed or initiated using the User Station.

The User Stations, in accordance with the instant invention, can be any “kiosk type” work platform conducive to user interaction and able to facilitate various I/O devices such as at least one monitor, a printer, a credit card reader, speakers, infrared PDA ports, and the like. Not all User Stations, which operate in accordance with the system of the instant invention, need to be configured identically or have the same capability. As previously described, each User Station in the system is indexed such that layered information and/or transaction traffic is selected or facilitated based on capability of the User Station by the System Transaction Manager.

In accordance with the instant invention, the User Station communicates with the Central Information Database through the System Transaction Manager. Each User Station has a CPU and storage capability so that batched information from the System Central Database can be downloaded to the User Station in a layered format and the presentation operating system protocol, which is based on the User Station, can be upgraded and/or changed via the communications link by operation through the System Transaction Manager. In operation, when the User Station is activated, the updated, residential, non-real time information stored on the User Station is prompted and the User Station protocol or operating system presents the data and/or transaction available from the site-specific User Station. The System Transaction Manager becomes aware that the User Station is online only by means of specific User Station commands, which require information from the Central Database or the User Station triggers a real time transaction such as access of a third party website, a credit card purchase, a car rental, an airline ticket or the like.

In the event that the action requested by the user at the User Station is retained locally on the User Station, for example, a restaurant guide, then the User Station by its internal operating system accesses the information on the User Station and presents it to the User. In this manner, no large look-up tables from central servers are required and the mean time to access is reduced. This is particularly important when multimedia information such as audio segments and video clips are desired. In this manner, a full advertising sequence can be presented from the User Station stored information in a smooth consistent and instantaneous manner without waiting for interconnect search and download from central devices.

In one embodiment, the User Station commands can be used to request update information from the Central Database by means of accessing the System Transaction Manager wherein the real time information provided is solely an update. Thus, the User Station may contain, for example, a local theater presentation show times and a real time populated theater sitting chart. Likewise, the User Station has real time third party interface capability through the System Transaction Manager either as a gateway or a facilitator. Thus, for example, purchased items such as souvenirs or articles of clothing can be purchased by use of, for example, a credit card transaction either from a Vendor/subscriber through the system on, for example, a web site.

System Administrator

The System Administrator is the control unit that dictates the sequences followed by the System Transaction Manager, as well as monitoring correctness of content format and appropriateness of content with authored protocol for a particular User Station. In essence the System Administrator sets up the “network Policy” upon which the system operates. It sets system policy so the data can be cached and/or sequenced in an orderly manner in accordance with priorities. In this manner, the System Administrator can set-up sequencing of the System Transaction Manager updates to Indexed User Stations, as well as priority of System Transaction Manager/User Station interaction.

When new content and/or protocol is available to be downloaded by the System Transaction Manager, the System Administrator presents a policy to activate a trigger which flags the System Transaction Manager to update Indexed User Station from the Central Database at the indicated time. For example, a Vendor/subscriber, who is an advertiser on a set of User Stations in a particular local, seasonally updates his line of goods to be displayed at the indicated User Stations. An example would be a sporting outlet changing from winter ski apparel to summer hiking, boating, and camping equipment. When the Vendor/subscriber updates the content and/or protocol (as previously described), the System Transaction Manager receives content, the format is checked for compatibility with the system, and the updated information is stored in the Central Database and indexed accordingly. Simultaneously the trigger is set according to the policy of the System Administrator. The System Transaction Manager updates Indexed User Station information for the local to receive the updated Vendor/subscriber content. This is done, for example, at 2:00 A.M. ET each day. At the appropriate update time the System Transaction Manager tests the indexed Vendor/subscriber content to determine whether a trigger has been set. If so, the System Transaction Manager downloads the updated content to the Indexed User Stations and deactivates the trigger such that if no new Vendor/subscriber information is present at the next scheduled download, the System Transaction Manager skips the download.

System Transaction Manager

The System Transaction Manager is the facilitator of the system of the instant invention. It populates the User Station, updates Vendor/subscriber information on the User Station, monitors updated Vendor/subscriber information from a Vendor/subscriber, sets triggers according to system policy, establishes system's operating protocol, as well as updating protocol to individual User Stations, responds to System Administrator scheduling, as well as real time demand for updated information from individual User Stations and can act as a gateway for third party interaction with the system.

The System Transaction Manager must test legacy protocol from Vendor/subscriber transferring Vendor/subscriber information to the Central Database and authenticate that the particular Vendor/subscriber is a subscriber to the system and acknowledge receipt of the content. In the event Vendor/subscriber information requires change of individual User Station protocol, the System Transaction Manager assures the protocol is installed in the User Station prior to updating the Vendor/subscriber information at that User Station. If the policy conditions cannot be met, a flag is set identifying the cached material for System Administrator intervention.

The System Transaction Manager intercepts real time commands and allows hyperlink or patch communication with third party information delivery systems and monitors the system protocol against the third party protocol to assure compatibility as well as presenting a firewall for the protection of the system.

As previously described, the User Station is Indexed so that the System Transaction Manager can manage data flow, including updating the content at a particular User Station. The data at the site-specific Indexed User Station is layered to provide capability for the System Transaction Manager to download index information and/or operations protocol to a particular User Station based on geographical and content criteria as preset in the index for the specific User Station. Thus, each User Station can provide, not only site-specific information, such as amenities for a hotel, but also local information such as nearby restaurants, shops, entertainment, venues, and the like. In addition, a specific User Station can provide regional activities and attractions, such as sports events, hiking, skiing, mountain claiming, etc. The specific User Station can also provide statewide attractions and point of interests as well as national happenings, news, and the like.

As is understood by the skilled artisan, the ability to provide an indexing scheme unique to a particular User Station allows the System Transaction Manager to manage and populate a particular User Station using a specified protocol or set of protocols to author format for the content in a dynamic manner such that triggers are acknowledged by the System Transaction Manager to update information and/or protocol on a pre-set schedule, an as available basis, or in response to a real time user command. The triggers for preset functions are “turned off” after the function is performed.

Another aspect involves real time transactions that are managed by the System Transaction Manager, but may provide a direct link between the User Station and, for example, Internet, ATM, or the like. An advantageous aspect of the instant system is the ability of the System Transaction Manager to monitor commands from the particular User Station to open “gateways” through, for example, applications service providers, or ISPs to allow users to transact business directly from the User Station. For example, a User Station in a hotel lobby could be equipped with the capability for direct link to certain Internet web access, such as Map Quest®, or the like, but be restricted from general Internet access. Likewise, a specific User Station in a hotel lobby could provide ATM accessibility to a myriad of banking interconnect through out the nation.

In accordance with another aspect, direct interface between the User Station and the System Transaction Manager allows the System Transaction Manager to respond to real time commands initiated by a User at the User Station to either provide interconnect links with third party data, i.e. that data not in the Central Database, such as national news, or the like. It will be understood by the skilled artisan that operation in this manner allows the flexibility of real time interconnect with the timeliness of updated stored data on the particular Indexed User Station. In this manner, the real time bandwidth of the link between the User Station and the System Transaction Manager is utilized primarily for interactive command flow, avoiding real time download/upload delays, as well as delays associated with search engines retrieving all information from a central database, as is present in the prior art.

The System Transaction Manager operates the system and manages the content and protocol, as well as populating Indexed User Stations in accordance with the System Administrator system policy. For example, if the protocol for a specific Indexed User Station is updated in order to, for example, institute a new display routine, the System Transaction Manager reads the priority trigger to update the protocol prior to updating any triggered content. In addition, prior to updating the triggered content, the System Transaction Manager tests the triggered content to determine compatibility with the updated protocol. In the event the content is not compatible with the updated protocol, the System Transaction Manager will not update the content on the Indexed User Station, but will set an alarm or flag, as previously described, so that the System Administrator can intervene to provide protocol/content compatibility.

The System Transaction Manager also optimizes use of interconnect bandwidth to minimize real time communication and look-up. In accordance with one aspect, the System Transaction Manager converts legacy Business Protocol to uniform system protocol such as XML, HTTP, and TCP/IP. The System Transaction Manager is advantageously located at the Central Database server. The System Transaction Manager also handles cleanup of errors due to such conditions as network interruptions, equipment failure, unreadable Indexes and the like.

Central Database

The Central Database is preferably maintained on an application server with direct communication link through the System Transaction Manager to Vendor/subscribers including Vendor/subscribers information as well as to each individual User Station. The construction of the look-up table is a system dynamic, which is predicated upon system use and ease of access of information by the System Transaction Manager. Once the Central Database is populated, the System Transaction Manager authenticates updates of Vendor/subscriber information, which can include both, content and protocol. An update of the Central Database causes a trigger to be set by the System Transaction Manager such that the System Transaction Manager will transfer the updated Vendor/subscriber information to all of those Indexed User Stations which are Indexed to receive same, in accordance with System Administrator sequence, or upon command from the User Station in accordance with a pre-set instruction protocol.

Thus, in accordance with the instant invention each User Station is continually updated with Vendor/subscriber information including display protocol in accordance with the schedule set by the System Administrator and/or a User Station command. If the Central Database information is not updated, the System Transaction Manager will skip the scheduled download as set by the System Administrator. Only when the Central Database contains updated information for particular User Stations is the trigger set in the System Transaction Manager to download on schedule. The update can be content or protocol as previously described.

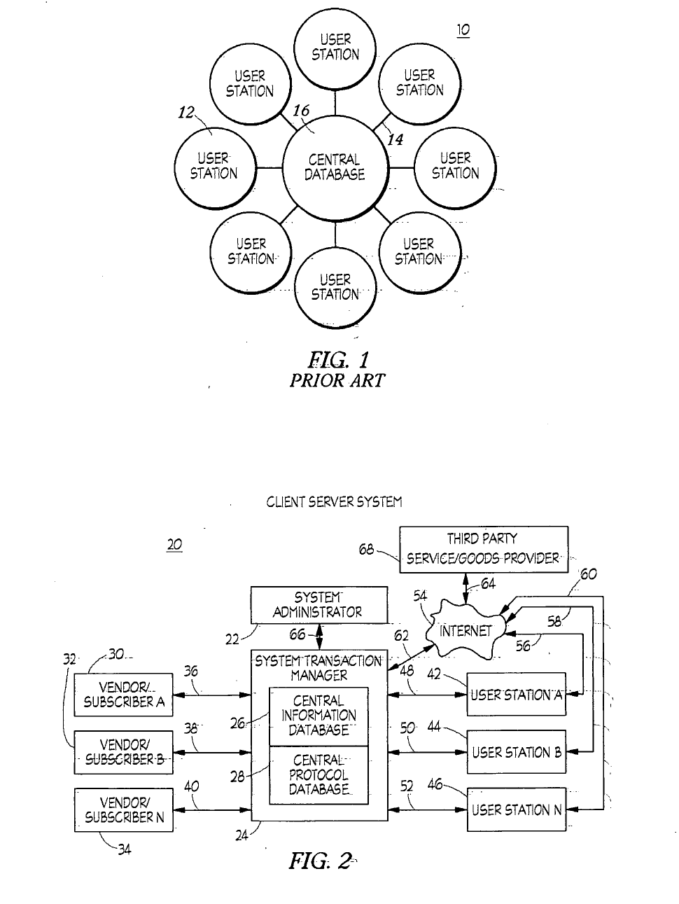

Turning to the figures, there is shown in FIG. 1, the prior art user station information exchange system 10. User station information exchange system 10 comprises a user station to Central Database link for each user station. In accordance with this user station information exchange system 10, a central database 16 is linked by way of link 14 to a number of individual user stations 12. Each user station 12 is substantially an interface with user (not shown) and provides input/output for the information contained in the central database 16. Thus, all content and protocol displayed on the individual user station 12 is the result of a real time interconnect with the central database 16. Additionally, the search engine employed by the central database 16 must in real time determine the content and protocol to be accessed by a specific user station and address that information. Thus, as can be seen, flexibility of this user station information exchange system becomes limited as the number of user stations becomes large. Additionally, the bandwidth of link 14 must not only provide interconnect handshake, but also capacity to download/upload information on a real time basis.

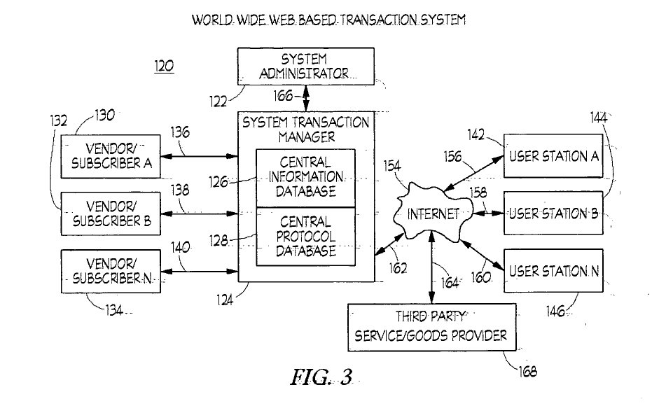

In accordance with the invention, FIG. 2 is exemplary of a “client/server” type system 20 with Internet interface. The client/server system 20 permits Vendor/subscriber “A,” “B,” and “N” to link with System Transaction Manager 24. The designation of “N” Vendor/subscribers illustrates that any number of Vendor/subscribers could be connected to the client/server system 20 of the instant invention. The System Transaction Manager 24 is, for example, computer microprocessor-based equipment residing at one or at multiple locations and is set up to communicate with the User Stations “A”, “B”, and ‘N’ for the required electronic communication. The System Transaction Manager 24 includes a Central Information Database 26 and a Central Protocol Database 28. Communications links 36, 38, and 40 functionally connect the Vendor/subscribers 30, 32, and 34, respectively, to the system transaction manager 24 by, for example, dial-up networking, Digital Subscriber Lines (“DSL”), Asymmetric Digital Subscriber Lines (“ADSL”), Virtual Private Network (“VPN”), cable, wireless technology such as IR, radio frequency, cell, and satellite, or any other high speed connection as made available by technological advances in communication systems and as practiced by those skilled in the relevant arts.

A System Administrator 22 sets client/server system 20 policy and interfaces with the system transaction manager 24 through link 66. User Stations (designated A, B, and N to indicate any number of stations in the system) 42, 44, and 46 communicate with the System Transaction Manager 24 via communications links 48, 50, and 52 respectively as well as through the Internet 54 by means of Internet communication links 56, 58, and 60 respectively. Internet 54 likewise communicates with the System Transaction Manager 24 by means of Internet connection 62.

The System Transaction Manager 24 operates the data flow in client/server system 20 in accordance with policy as set by the System Administrator 22. Information data within Central Information Database 26 is indexed to provide System Transaction Manager 24 instructions for populating and managing information data to and from Indexed User Stations 42, 44, and 46 via communication links 48, 50, and 52. Central Protocol Database 28 contains system protocol, as previously described, which may comprise operating protocol for the system as well as individual user station protocol, which is associated with indexed information data contained in the Central Information Database 26.

Thus, the System Transaction Manager 24, in accordance with the indexed data, initially populates User Stations 42, 44, and 46 with layered, location specific data, which is directed by means of the index. Along with the information data population System Transaction Manager 24 downloads appropriate operating protocol, again based on indexing, to render Indexed User Stations 42, 44, and 46 operative. The protocol is authored to perform a myriad of functions at each Indexed User Station, such as User/User Station interface, communication protocol, audio/video display protocol, and the like. In accordance with the invention, the operating system for each individual User Station is usually installed with the user station such that the communication links 48, 50, and 52 are active and the System Transaction Manager 24 can address and interact with the user stations, including turning the station on, monitoring transactions, allowing third party interface, and the like.

Vendor/subscribers 30, 32, and 34 generate content and/or protocol for the client/server system 20. The Vendor/subscriber can be onsite, such as a hotel housing a user station, or remote, such as a restaurant or merchandiser. Content is generated in a form, as previously described, and transmitted via data links 36, 38, and 40 to the System Transaction Manager 24. In some cases protocol, usually display protocol, is transferred with the content. This is especially true when the content requires a particular formatting and/or set of operations to adequately present the information from the vendor/subscriber to the user at a User Station. The System Transaction Manager 24, with appropriate data identification, prioritizes the information in accordance with the policy set by System Administrator 22 to for storage, indexing and then caches the information generated by the vendor/subscriber. In addition, as previously described a trigger is set indicating that the information is new. The System Transaction Manager 24 then tests the cache of information to determine the protocol requirements.

If the protocol accompanies the content, the protocol is stripped and indexed for storage in the central protocol database with an appropriate associating trigger such that the protocol update is transmitted to the Indexed User Station prior to the content. The System Transaction Manager 24 determines whether the indexed user station contains appropriate protocol to handle the content as well as the functionality of the content, then tests the cached information to determine system compatibility. If the cached information does not meet system requirements the information is flagged as previously described.

In accordance with one aspect, System Transaction Manager 24 tests the indexed user station by means of data links 48, 50, and 52 to determine the onsite operating system and protocol. In the event the user station to receive the content does not have a functionality, which is compatible and that functionality cannot be updated by means of transmission of system or operating protocol stored in Central Protocol Database 28, then an error flag is send to the System Administrator 22.

In one embodiment, using system software installed “on-site” at the Indexed User Stations 42, 44, and 46 and configured as dial-up, User Stations 42, 44, and 46 automatically access the System Transaction Manager 24 via communications links 48, 50, and 52 respectively to update information.

As shown in FIG. 2, the client/server system 20 provides access to third party service and goods providers 68 via the Internet 54. Internet 54 is linked to User Station 42, User Station 44, and User Station 46 by means of links 56, 58, and 60 respectively. System Transaction Manager 24 is also connected to the Internet 54 via link 62. The third party service/goods provider 68 is likewise connected via link 64. In addition to the links 48, 50, and 52 links are also provided through the Internet 54, as described, such that System Transaction Manager 24 provides either a gateway to Internet 54 via link 62 or allows monitored direct access of User Stations 42, 44, and 46 to the Internet 54. In accordance with this embodiment, System Transaction Manager 24 via links 48, 50, and 52 or via link 62 to the Internet 54 by way of links of 56, 58, and 60 can limit Internet 54 accessibility of Indexed User Stations 42, 44, and 46.

In accordance with this aspect, functionality of User Stations 42, 44, and 46 can include direct interaction with third party service/goods provider 68 through Internet 54. This provides web-based functionality for User Station access outside of client/server system 20. In operation, a Vendor/subscriber can display advertising information on a user station and a user at the user station can purchase the advertised goods directly from the user station by means of web site access through Internet 54. Likewise, local site-specific information at a User Station, such as theater performances and the like, can provide information for a User to use the User Station through the Internet 54 to acquire tickets for the performances as previously described.

It will be realized that, in accordance with this embodiment, the System Transaction Manager has control over Internet access of all user stations on the system either by acting as a gateway or limiting protocol directly on the User Station.

The System Transaction Manager permits Users interface with the system of the present invention with minimal alterations or disruptions of their local User Station. The System Transaction Manager performs all the formatting changes, which are necessary for different Users to communicate with third parties, automatically.

The Normalized Data Format used by the present invention can be any well-known data formatting protocol. For example, the Normalized Data Format can be the extended markup language (XML). Alternatively, for the systems of the present invention that link together the constituent Users over the Internet, the Normalized Data Format can be FTP, TCP/IP, or http standard used on the Internet.

In operation, the System Transaction Manager, reads and logs the Vendor/subscriber information, assigns an Indexed User Station application protocol, depending on the dissemination rule triggered by the Vendor/subscriber information, and assigns a transaction ID for tracking purposes. In this manner the Vendor/subscriber information that is acknowledged; moved to the System Data Base and noted as a “completed transaction,” catalogued and the update trigger is set in the system. The System Transaction Manager then, prepares the Vendor/subscriber information for routing to the specified User Station according to the download time designator, which may be set on interval and/or opportunity as set by the System Administrator. By queuing the Vendor/subscriber information as an update into an appropriate cache, depending on the priority assignment, and routing information contained in the Vendor/subscriber Information and/or as set by the System Administrator, the system will transfer the information to the User Station in accordance with the system protocol.

If the System Transaction Manager determines that a User Station has blocked a specific type of Vendor/subscriber Information or Vendor/subscriber information from a specific Vendor/subscriber then the Vendor/subscriber information is cached and the Vendor/subscriber notified.

In one aspect, the System Transaction Manager provides an Industry Application Programming Interface for developed programs that allows Vendor/subscribers to be able to uniquely request specific Indexed User Stations as well as be able to issue vendor information for products, services, and information to targeted User Stations related to that industry by specifying a service type (i.e. pricing), an item to be priced (e.g. clothes), and a target(s). The System Transaction Manager provides routing to the appropriate User Stations based on the targeted User Stations or set of User Stations as identified by the generating Vendor/subscriber. Likewise, User Stations could prohibit receipt of certain Vendor/subscriber information or Vendor/subscriber information from a specific Vendor/subscriber as discussed above.

In one aspect, the communications link is a private secure link. In accordance with another aspect, the communications link is a pre-existing, public system such as the Internet. In accordance with an advantageous embodiment contemplated herein, a single centralized System Transaction Manager is provided. In another embodiment, a plurality of System Transaction Managers communicates with the Indexed User Stations and in turn with a central System Transaction Manager in a multi-tiered system.

Status information indicating the User Station status at any given moment, as well as a bit flags containing information as to what processing remains, is contained in a subset to allow for rapid transmission of status information back to the System Transaction Manager for both operability confirmation, as well as progress indication. Index codes are used to uniquely log each User Station status.

Referring now to FIG. 3, there is shown a block diagram of another preferred embodiment of the present invention. This embodiment supports the inventive system over the Internet using, for example, the World Wide Web (“Web”). A Web-based system 120 permits Vendor/subscribers “A” 130, “B” 132, and “N” 134 to link with the Web-based system 120. The designation of “N” Vendor/subscribers illustrates that any number of Vendor/subscribers could be connected to the System Transaction Manager 124. The System Transaction Manager 124 is, for example, computer microprocessor-based equipment residing at one or at multiple locations and is set up to communicate with the user stations 142 “A”, 144 “B”, and “N” 146 for the required electronic communication.

The System Transaction Manager 124 includes a Central Information Database 126 and a Central Protocol Database 128 Communications links 136, 138, and 140 functionally connect the Vendor/subscribers 130, 132, and 134, respectively, to the system transaction manager 124 by, for example, the Internet, dial-up networking, Digital Subscriber Line (“DSL”), Asymmetric Digital Subscriber Line (“ADSL”), Virtual Private Network (“VPN”), wireless technology such as IR, cell or radio frequency, Satellite links, cable, or any other high speed connection as made available by technological advances in communication systems and as practiced by those skilled in the relevant arts.

A System Administrator 122 sets World Wide Web Based Transaction System 120 policy and interfaces with the System Transaction Manager 124 through link 166. User Stations 142, 144, and 146 communicate with the System Transaction Manager 124, via the Internet 154, by means of Internet communications links 156, 158, and 160 respectively and Internet connection 162.

The System Transaction Manager 124 operates the data flow in World Wide Web Based Transaction System 120 in accordance with policy as set by the System Administrator 122. Information data within Central Information Database 126 is indexed to provide System Transaction Manager 124 instructions for populating and managing information data to and from Indexed User Stations 142, 144, and 146. Central Protocol Database 128 contains system protocol, as previously described, which may comprise operating protocol for the system as well as individual user station protocol, which is associated with indexed information data contained in the Central Information Database 126.

Thus, the System Transaction Manager 124, in accordance with the indexed data, initially populates User Stations 142, 144, and 146 with layered, location specific information data, which is directed by means of the index via Internet 154 by means of link 162 and User Station links 160,158, and 156. Along with the information data population System Transaction Manager 124 downloads appropriate operating protocol, again based on indexing, to render Indexed User Stations 142, 144, and 146 operative.

As in the embodiment in FIG. 2, the protocol is authored to perform a myriad of functions at each user station, such as User/User Station interface, communication protocol, audio/video display protocol, and the like. In accordance with the invention, the operating system for each individual User Station is usually installed with the User Station such that the Internet communication links 156, 158, and 160 are active and the System Transaction Manager 124 can address and interact with the user stations including the turning the station on, monitoring transactions, allowing third party interface, and the like.

Vendor/subscribers 130, 132, and 134 generate content and/or protocol for the World Wide Web Based Transaction System 120. The Vendor/subscriber can be onsite, such as a hotel housing a user station, or remote, such as a restaurant or merchandiser. Content is generated in a form, as previously described, and transmitted via data links 136, 138, and 140 to the System Transaction Manager 124. The system functions in a manner similar to that fully described in FIG. 2, using the Internet and the respective internet links to provide the communications link for the World Wide Web Based Transaction System 120

One skilled in the art will appreciate that the above-described system can be used in various environments other than the Internet. Such alternate communications channels include, but are not limited to, local area network, wide area network, or, as described above, point-to-point dial up connections. Additionally, a User Station may comprise any combination of hardware or software that can offer functionality within the system and/or interface with third party service/goods provider.

All of the methods and systems disclosed and claimed herein can be made and executed without undue experimentation in light of the present disclosure. While the methods and systems of this invention have been described in terms of embodiments, it will be apparent to those of skill in the art that variations may be applied to the methods and systems and in the steps or in the sequence of steps of the methods described herein without departing from the concept, spirit and scope of the invention. Various substitutions can be made to the hardware and software systems described without departing from the spirit of the invention. All such similar substitutes and modifications apparent to those skilled in the art are deemed to be within the spirit, scope, and concept of the invention as defined by the appended claims.

1. A system for populating and managing multiple, site-specific, interactive, indexed user stations in accordance with a preset schedule or user command comprising:
a) at least one system transaction manager, for facilitating the population of said multiple indexed user stations with site-specific, layered, information;
b) at least two indexed user stations, in communication with said system transaction manager, able to store site-specific, layered information for retrieval and use by a user at the user station, and able to receive and store updated site-specific, layered information;
c) at least one central database, in communication with said system transaction manager, able to receive and store updated indexed, site-specific, layered information wherein said at least one central database transmits said updated indexed, site-specific, layered information upon command from said at least one system transaction manager in accordance with said preset schedule or user command to the indicated indexed user station, by way of said system transaction manager communications link.

2. The system of claim 1 wherein said at least one central database comprises an information database and a protocol database.

3. The system of claim 1 wherein said site-specific, layered information includes a content component and a protocol component.

4. The system of claim 1 wherein said at least two indexed user stations operate in accordance with an updateable site-specific operating protocol.

5. The system of claim 1 wherein said system operates using a uniform system protocol.

6. The system of claim 1 wherein said information is generated, at least in part, by a vendor/subscriber in communication with said system transaction manager.

7. The system of claim 6 wherein said information comprises content and protocol.

8. The system of claim 1 wherein said updated indexed, site-specific, layered information is received, stored and transmitted in accordance with a system policy.

9. The system of claim 8 wherein a systems administrator establishes said system policy.

10. The system of claim 1 wherein said communication links are selected from dial-up networking, Digital Subscriber Lines, Asymmetric Digital Subscriber Lines, Virtual Private Network, LAN, WAN, cable, IR, radio frequency, cell, Internet, Intranet, satellite, and combinations thereof.

11. The system of claim 1 wherein said system transaction manager has at least one transaction interconnect with at least one third party service/goods provider for conducting information based transactions; and, said at least two indexed user stations have functionality such that information based transactions with a third party service/goods provider can be conducted.

12. The system of claim 1 wherein said at least two indexed user stations provide multimedia display.

13. A system for selectively populating and managing site-specific, multimedia, indexed user stations for selectively communicating information to a user and conducting information related transactions comprising:
a) at least two multimedia, indexed, user stations for communicating site-specific information to a user and conducting information based transactions, having an updateable operating protocol and means for storing said information for use by a user at the user station, and being able to receive and store updated site-specific, layered information including an operating protocol;
b) at least one system transaction manager, in communication with said at least two indexed user stations, for selectively populating and managing site-specific, layered, information and facilitating said information based transactions on said indexed user stations;
c) at least one information generating entity, in communication with said system transaction manager, for generating updated information including authored presentation protocol;
d) at least one central database, in communication with said system transaction manager, able to receive and store updated indexed, site-specific, layered information including protocol;
e) at least one transaction interconnect, in communication with said System Transaction Manager, for conducting information based transactions at said user stations;
f) at least one system administrator, in communication with said system transaction manager, for selectively setting system policy wherein said system transaction manager provides said updated indexed, site-specific, layered information in accordance with said system policy or user command, to the indicated indexed user station from said central database for storage on said indexed user stations.

14. The system of claim 13 wherein said at least one central database comprises an information database and a protocol database.

15. The system of claim 13 wherein said site-specific, layered information includes a content component and a protocol component.

16. The system of claim 13 wherein said at least two indexed user stations operate in accordance with an updateable site-specific operating protocol.

17. The system of claim 13 wherein said system operates using a uniform system protocol.

18. The system of claim 13 wherein said at least one information generating entity is a vendor/subscriber.

19. The system of claim 13 wherein said communication links are selected from dial-up networking, Digital Subscriber Lines, Asymmetric Digital Subscriber Lines, Virtual Private Network, LAN, WAN, cable, IR, radio frequency, cell, Internet, Intranet, satellite, and combinations thereof.
